(19) United States
(12) Patent Application Publication
(10) Pub. No.: US 2026/0048698 A1
(43) Pub. Date: Feb. 19, 2026

(54) GEAR RACK ASSISTED LINEAR GUIDE OR LINEAR BEARING SYSTEM FOR VEHICLE COMPARTMENT SLIDING MECHANISM

(71) Applicants: Xinfang Zhang, Shanxi (CN); Hengyuan Zhang, Shanxi (CN)

(72) Inventors: Xinfang Zhang, Shanxi (CN); Hengyuan Zhang, Shanxi (CN)

(21) Appl. No.: 18/808,077

(22) Filed: Aug. 19, 2024

(51) Int. Cl. B60P 3/34; F16C 29/02

(52) U.S. Cl. CPC B60P 3/34; F16C 29/02; F16C 2326/01

(57) ABSTRACT

The present application relates to the technical field of expanding the internal space of a vehicle, and in particular to a vehicle box slide-out system, which includes a slide-out box, a driving device, a sliding assembly, a support frame, and a bearing box assembly. The slide-out box is arranged at the opening of the vehicle body. The vehicle box can be arranged at the opening of the vehicle body by simply fixing the bottom plate of the support frame to the vehicle body. The present application can realize the sliding out and retraction of the vehicle slide-out box, increase the internal use space of the vehicle, be neat and beautiful, and be easy to install and disassemble.

### TECHNICAL FIELD

The present invention pertains to the field of vehicle interior space expansion technologies, and more specifically, to a vehicle compartment slide-out system featuring a rack linear guide or linear bearing.

### BACKGROUND OF THE INVENTION

Existing vehicles and recreational vehicles, or RVs employ slide-out modules to augment the interior's usable area. During transit, the outer walls of these slide-out compartments align flush with the vehicle's exterior, ensuring aerodynamic efficiency and travel safety. When the vehicle is stationary, the slide-out modules can be extended outward from the vehicle's opening, instantly increasing the living or working space inside.

US Patent Application Publication No. US202117408020A discloses a slide-out mechanism arranged on both sides of the slide-out compartment. Due to the complexity of the employed mechanism and the large space occupied by the telescopic drive device, maintenance is inconvenient, leading to increased operational costs.

In response to the pertinent technology mentioned above, the inventors recognize that the slide-out mechanism of the vehicle compartment slide-out systems tends to be bulky, complicated to install, and relatively expensive. Consequently, it is acknowledged that the slide-out mechanism for vehicle slide-out compartments presents an issue of occupying considerable space.

### SUMMARY OF THE INVENTION

To improve the defect that the sliding-out mechanism of a vehicle's slide-out box occupies a large space, the present invention provides a vehicle box slide-out system, in which the sliding-out mechanism of the vehicle box slide-out system is integrated and arranged at the lower part of the corresponding two sides of the slide-out box, occupying a small space, and being neat and beautiful. There is no need to disassemble the lower chassis of the vehicle body. Only the bottom plate of the support frame needs to be fixed to the vehicle body. The vehicle box slide-out system can then be arranged at the opening of the vehicle body, and the slide-out box can be slid out and retracted, thereby increasing the use space of the vehicle, and facilitating installation and disassembly.

### DETAILED DESCRIPTION OF THE PREFERRED EMBODIMENTS

To achieve the above object, the present invention adopts the following technical solutions:

A vehicle box slide-out system comprises a slide-out box, a drive device, a sliding assembly, a support frame and a carriage box assembly, wherein the slide-out box is arranged at an opening of the vehicle body, the drive device is engaged with the sliding assembly, the sliding assembly is fixed above the support frame. The sliding assembly, the drive device and part of the support frame are integrated inside the carriage box assembly, a long strip opening is arranged at the bottom of the carriage box assembly, and the carriage box assembly slides back and forth at the lower end of the support frame through the long strip opening.

By adopting the above technical solution, the sliding assembly, the driving device, and part of the support frame are integrated in the carriage box assembly, which can isolate the sliding assembly and the driving device from the outside world, facilitate installation and disassembly, have a beautiful appearance, and can increase the internal usable space of the vehicle.

The sliding assembly involves three structures: a rack and guide rail combined sliding assembly or an integrated rack and guide rail assembly or a rack and linear shaft combined sliding assembly. The rack and guide rail combined sliding assembly includes a guide rail, a linear block, a first rack and a rack mounted bracket. The guide rail is slidably connected to the linear block, one end of the guide rail is provided with a combined guide rail first fixing hole, the other end is provided with a combined guide rail second fixing hole, the top of the guide rail is provided with multiple combined guide rail third fixing hole, the rack mounted bracket is provided with multiple rack mounted bracket first hole and rack mounted bracket second hole. The combined guide rail third fixing hole and the rack mounted bracket second hole are arranged correspondingly, and are used to connect the guide rail and the rack mounted bracket, the first rack is provided with multiple first rack connecting hole one, the first rack connecting hole one and the rack mounted bracket first hole are arranged correspondingly, and are used to connect the first rack and the rack mounted bracket, the first rack is fixed to the guide rail through the rack mounted bracket, and the guide rail is slidably fixed in the linear block.

By adopting the above technical solution, the guide rail can slide in the linear block to reduce friction, the rack and the guide rail are combined and connected to perform linear motion, and the linear block can bear the weight transmitted by the guide rail.

The integrated rack and guide rail assembly comprises a rack and guide rail composite body and a linear block; the rack and guide rail composite body is provided with a second rack and a guide rail as a whole; one end of the rack and guide rail composite body is provided with a complex third fixing hole, and the other end is provided with a complex fourth fixing hole; the rack and guide rail composite body is slidably fixed in the linear block.

By adopting the above technical solution, the integrated rack and guide rail assembly has a simpler structure than the rack guide rail combined sliding assembly and can also realize the linear motion driven by the rack, making production and installation more convenient.

The rack and linear shaft combined sliding assembly includes a third rack, a third rack connecting hole three, a linear open slider, an open slider fixing hole, a linear shaft, multiple linear shaft fixing holes, a linear shaft bracket, multiple bracket first fixing hole and bracket second fixing hole, a linear shaft fifth fixing hole, a linear shaft sixth fixing hole, a third flange 6C, a fourth flange 6D; the third rack connecting hole three is correspondingly arranged with the bracket second fixing hole, and is used to connect the third rack and the linear shaft bracket, the bracket first fixing hole and the linear shaft fixing hole are correspondingly arranged, and are used to connect the linear shaft bracket and the linear shaft; the third rack is fixedly connected to the linear shaft through the linear shaft bracket, and the linear shaft is slidably fixed inside the linear open slider.

By adopting the above technical solution, it is equally possible to achieve the support and linear motion of the linear shaft by third rack, and the linear bearing is lower in cost and easier to install compared to the combination of rack and guide rail.

The driving device includes a driving seat, a motor, a reducer and a gear. The output shaft of the motor is connected to the reducer, which is mounted on the drive base. The gear is attached to the output shaft of the reducer. The motor drives the rotation of the gear through the reducer, and this gear meshes with the first rack, the rack and guide rail complex, or third rack, thus converting rotational motion into linear motion.

By adopting the above technical solution, the gear of the driving device can drive the rack or the rack and guide complex or the third rack to slide and convert the spiral motion into the linear motion.

Multiple fixing holes are provided on the linear block or linear open slider, and multiple drive seat mounting holes are provided on the drive seat. The drive seat mounting holes are arranged corresponding to the linear block or the linear open slider fixing hole and is used to fix the drive seat on the block or slider.

By adopting the above technical solution, the linear block or the linear open slider can bear the load of the driving seat.

The support frame comprises a top plate, a vertical plate and a bottom plate, the top plate has first end face and second end face. The linear block or linear open slider is fixed on the top plate, the bottom plate is mounted on the vehicle body, and the carriage box assembly slides back and forth on both sides of the vertical plate through the long strip opening.

By adopting the above technical solution, the block or slider is fixed on the top plate, and the weight carried by the block or slider, or the linear open slider can be transferred to the top plate of the support frame. The long strip opening at the bottom of the bearing box passes through the vertical plate of the support frame, and the bottom plate supports the entire slide-out box body. There is no need to disassemble the vehicle chassis. The bottom plate of the support frame is directly fixed to the vehicle body, and the entire slide-out box body is suspended at the opening of the vehicle, and the support frame transfers the weight of the slide-out box body to the vehicle body.

The carriage box assembly comprises a bearing box body, a load-bearing inspection plate, a load-bearing plate, first flange and second flange or third flange and fourth flange. A load-bearing inspection plate is installed at one end of the bearing box body in the length direction, and a load-bearing plate is installed at the other end. One end of the guide rail or rack and guide rail complex or linear shaft is fixed to the load-bearing inspection plate through first flange or third flange, and the other end is fixed to the load-bearing plate through second flange or fourth flange.

By adopting the above technical solution, first flange and second flange or third flange and fourth flange can bear the weight of the guide rail or rack and guide rail complex or linear shaft and transfer the weight to the load-bearing inspection plate and the load-bearing plate. In addition, the guide rail or rack guide rail complex or linear shaft can drive the carriage box assembly to reciprocate. When the slide-out box slides out, the first flange touches the first end face, and the sliding process ends. When the slide-out box retracts, the second flange or fourth flange touches the second end face, and the retracting process ends.

The load-bearing inspection plate is provided with multiple flange fixing hole one and guide rail first connecting hole, the first flange or third flange is fixed on the load-bearing inspection plate through the flange first fixing hole, the first flange or third flange is provided with the guide rail support hole one or the shaft third support hole that allow the guide rail or the rack and guide rail complex or the linear shaft to pass through. An end of the guide rail, which could be a linear guide or a rack and pinion rail, or a linear shaft passes through a specific flange (first flange or third flange). It then connects to a critical component, the guide rail first connecting hole, via an appropriate mounting hole (combined guide rail first fixing hole, complex third fixing hole, or linear shaft fifth fixing hole). Ultimately, this assembly is secured onto the load-bearing inspection plate.

The load-bearing plate is provided with a flange second fixing hole and multiple guide rail second connecting hole, and the second flange or fourth flange is provided with a guide rail support hole two or a shaft fourth support hole through which the guide rail or the rack and guide rail complex or the linear shaft combination can pass. And the other end of the guide rail, which could be a linear guide or a rack and pinion rail, or a linear shaft passes through a specific flange (second flange or fourth flange). It then connects to a critical component, the guide rail second connecting hole, via an appropriate mounting hole (combined guide rail third fixing hole, complex fourth fixing hole, or linear shaft sixth fixing hole). Ultimately, this assembly is secured onto the load-bearing plate.

By adopting the above technical solution, one end of the guide rail or the rack and guide rail complex or the linear shaft can be fixed on the load-bearing inspection plate through first flange or third flange, and the other end can be fixed on the load-bearing plate through second flange or fourth flange, so that the load-bearing inspection plate and the load-bearing plate can bear the weight of the guide rail or the rack and guide rail complex or the linear shaft.

Preferably, the load-bearing inspection plate is removable.

By adopting the above technical solution, when a fault occurs inside the carriage box assembly, it can be repaired by removing the load-bearing inspection plate, thereby reducing the maintenance cost.

The carriage box assembly further comprises a control assembly, and the control assembly is arranged on a side wall inside the carrying box body.

By adopting the above technical solution, when the two carrying box components move asynchronously, the control component can detect the corresponding information. This detected information is then relayed to the controller, which performs the appropriate actions based on the received data.

By adopting the above technical solution, when the slide-out box is retracted, the control component detects the presence of the vertical plate of the support frame. Upon detection, the retraction movement stops, and the slide-out box is completely retracted.

In summary, the present application includes at least one of the following beneficial technical effects:
1. The sliding assembly, the driving device, and part of the support frame are integrated in the carriage box assembly, which can isolate the sliding assembly and the driving device from the outside world, facilitate installation and disassembly, have a beautiful appearance, and can increase the internal use space of the vehicle.
2. There is no need to disassemble the vehicle chassis. The bottom plate of the support frame is directly fixed to the vehicle body. The entire slide-out box is suspended at the opening of the vehicle, and the bottom plate of the support frame transfers the weight of the slide-out box to the vehicle body.
3. The load-bearing inspection plate on the carriage box assembly is removable. When a fault occurs inside the load-carriage box assembly, it can be repaired by removing the load-bearing inspection panel, thereby reducing the maintenance cost.

### BRIEF DESCRIPTION OF DRAWINGS

To more clearly illustrate the technical solution of the present invention, the drawings required for use in the description will be briefly introduced below. Obviously, the drawings described below are only some embodiments of the present invention. For professional and technical personnel in this field, other drawings can be obtained based on these drawings without paying for creative work.

FIG. 1 is an oblique view of the slide-out box fully extended from the opening of the vehicle body in the specific embodiment of the invention.

FIG. 2 is an oblique view of the slide-out box fully retracted into the opening of the vehicle body in the specific embodiment of the invention.

FIG. 3 is a front view of the slide-out box in the specific embodiment of the invention.

FIG. 4 is a diagram showing the internal structure of the bearing box in the specific embodiment of the invention.

FIG. 5 is an exploded view of the rack and guide rail combination sliding assembly in the specific embodiment of the invention.

FIG. 6 is an exploded view of the integrated rack and guide rail sliding assembly in the specific embodiment of the invention.

FIG. 7 is an exploded view of the rack and linear shaft combination sliding assembly in the specific embodiment of the invention.

FIG. 8 is an exploded view of the drive device in the specific embodiment of the invention.

FIG. 9 is a structural diagram of the support frame in the specific embodiment of the invention.

FIG. 10 is an exploded view of the carriage box assembly in the specific embodiment of the invention.

FIG. 11 is an exploded view showing the internal structure of the bearing box in the specific embodiment of the invention.

FIG. 12A is a front view of the internal structure of the carriage box assembly in the specific embodiment of the invention.

FIG. 12B is a rear view of the internal structure of the carriage box assembly in the specific embodiment of the invention.

FIG. 13 is an internal structural diagram of the slide-out box fully extended in the specific embodiment of the invention.

FIG. 14 is an internal structural diagram of the slide-out box fully retracted in the specific embodiment of the invention.

FIG. 15 is a cross-sectional view during the extension process of the slide-out box in the specific embodiment of the invention.

FIG. 15A is a cross-sectional view before the extension system activates.

FIG. 15B is a cross-sectional view when the slide-out box is fully extended.

FIG. 15C is a side view when the slide-out box is fully extended.

FIG. 15D is a partial cross-sectional view when the slide-out box is fully extended.

FIG. 16 is a cross-sectional view during the retraction process of the slide-out box in the specific embodiment of the invention.

FIG. 16A is a cross-sectional view when the slide-out box is fully extended.

FIG. 16B is a cross-sectional view when the slide-out box is fully retracted.

FIG. 16C is a side view when the slide-out box is fully retracted.

FIG. 16D is a partial cross-sectional view when the slide-out box is fully retracted.

### BRIEF DESCRIPTION OF THE FIGS

Follow are the reference numbers appear in the drawings:
1. Slide-out box
2. Bearing box
3. Support frame, 301. Top plate, 302. Vertical plate, 303. Bottom plate, 304A. First end face, 304B. Second end face
4. Linear Block, 401. Linear Block Fixing Hole
5. Guide Rail, 501A. Combined guide rail first fixing hole, 502A. Combined guide rail second fixing hole, 503. Combined guide rail third fixing hole, 5B. Rack and guide rail complex, 501B. Complex third fixing hole, 502B. Complex fourth fixing hole, 501C. Linear shaft fifth fixing hole, 502C. Linear shaft sixth fixing hole
6A. First flange, 6B. Second flange, 6C. Third flange, 6D. Fourth flange, 601. Guide rail first support opening hole, 602. Guide rail second support opening hole, 601C. Shaft third support hole, 602C. Shaft fourth support hole
7. Rack mounted bracket, 701. Rack mounted bracket first hole, 702. Rack mounted bracket second hole
8. First rack, 8B. Second rack, 8C. Third rack, 801. First rack first connection hole, 801C. Third rack third connection hole
9. Motor
10. Reducer
11. Drive seat
12. Control component
13. Gear
14. Load-bearing inspection plate
15. Load-bearing plate
16. Long opening
19. Flange first fixing hole
20. Flange second fixing hole
21. Guide rail first connecting hole
22. Guide rail second connecting hole
23. Drive seat mounting hole
24. Carriage box assembly
25. Driving device
26. Sliding assembly, 26A. Rack and guide rail combined sliding assembly, 26B. Integrated rack and guide rail sliding assembly, 26C. Rack and linear shaft combined sliding assembly, 261. Linear open slider, 262. Linear open slider fixing hole, 263. Linear shaft, 264. Linear shaft fixing hole, 265. Linear shaft bracket, 266. Bracket first fixing hole, 267. Bracket second fixing hole
27. Vehicle body

### DETAILED DESCRIPTION OF THE INVENTION

To clarify and highlight the purpose, features, and advantages of the present invention, the technical scheme of the present invention will be clearly and completely described below in conjunction with the drawings in this specific embodiment. Obviously, the embodiments described below are only part of the embodiments of the present invention, not all of them. Based on the embodiments in this patent, all other embodiments obtained by ordinary technicians in this field without creative work are within the scope of protection of this patent.

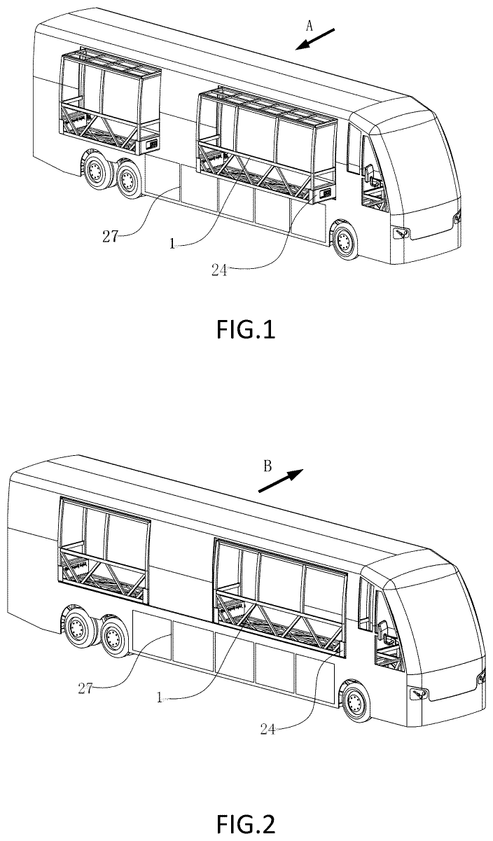

According to FIGS. 1 and 2, when the vehicle is stationary, the slide-out box 1 completely slides out from the opening of the vehicle body 27, increasing the usable space inside the vehicle body 27. After being retracted, the slide-out box 1 is flush with the exterior of the vehicle body 27, without affecting the overall aesthetic effect. A carriage box assembly 24 is mounted at the lower part of the one side wall of the slide-out box 1.

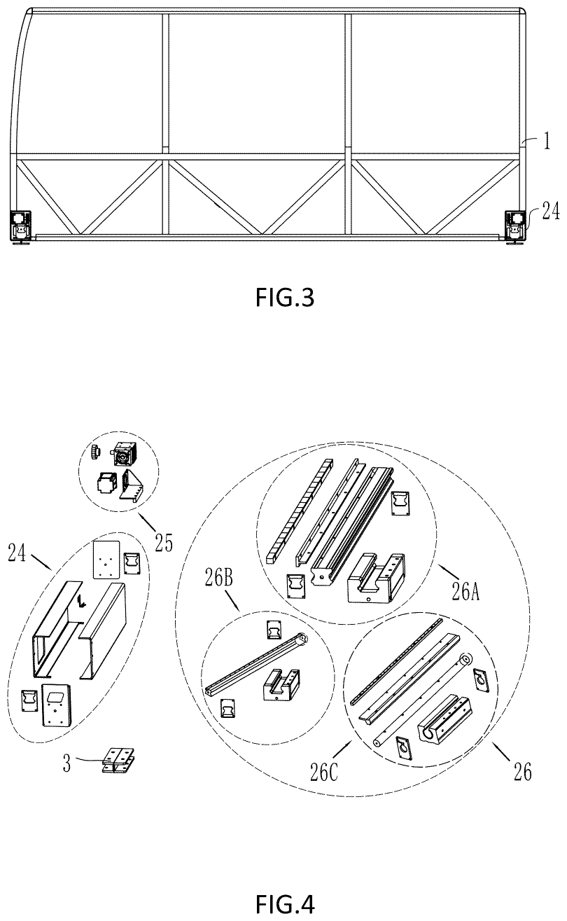

Referring to FIGS. 3 and 4, a vehicle box slide-out mechanism includes a slide-out box 1, a carriage box assembly 24, a driving device 25, a sliding assembly 26 and a support frame 3. The slide-out box 1 is made of aluminum alloy or other materials with relatively light structural rigidity. Corresponding carriage box assemblies 24 are arranged at the lower part of the opposite side walls of the slide-out box 1. The two carriage box assemblies 24 have the same internal structure, are arranged correspondingly, move synchronously, and bear the weight of the slide-out box 1. The driving device 25, the sliding assembly 26 and part of the support frame 3 are integrated inside the carriage box assembly 24, which can save space and facilitate quick installation and disassembly. The sliding assembly 26 has three types, as shown by the arrows in the figure, namely, a rack and guide rail combined sliding assembly 26A, an integrated rack and guide rail sliding assembly 26B and a rack and linear shaft combined sliding assembly 26C.

As shown in FIG. 5, the rack and guide rail combined sliding assembly 26A includes a linear block 4, a guide rail 5, a first flange 6A, a second flange 6B, a rack mounted bracket 7 and a first rack 8. The linear block 4 is provided with multiple linear block fixing holes 401, one end of the guide rail 5 is provided with a combined guide rail first fixing hole 501A, through the first flange 6A to be fixed to the bearing box 2. The other end is provided with a combined guide rail second fixing hole 502A, through the second flange 6B to be fixed to the bearing box 2. And the top is provided with multiple combined guide rail third fixing hole 503. The guide rail 5 is slidably connected with the linear block 4. The rack mounted bracket 7 is provided with multiple rack mounted bracket first hole 701 and rack mounted bracket second hole 702. The rack mounted bracket second hole 702 and the combined guide rail third fixing hole 503 are correspondingly arranged to connect the guide rail 5 and the rack mounted bracket 7. The first rack 8 is provided with multiple first rack first connection hole 801. The first rack first connection hole 801 and the rack mounted bracket first hole 701 are correspondingly arranged to connect the first rack 8 and the rack mounted bracket 7. The first rack 8 is fixed to the guide rail 5 through the rack mounted bracket 7.

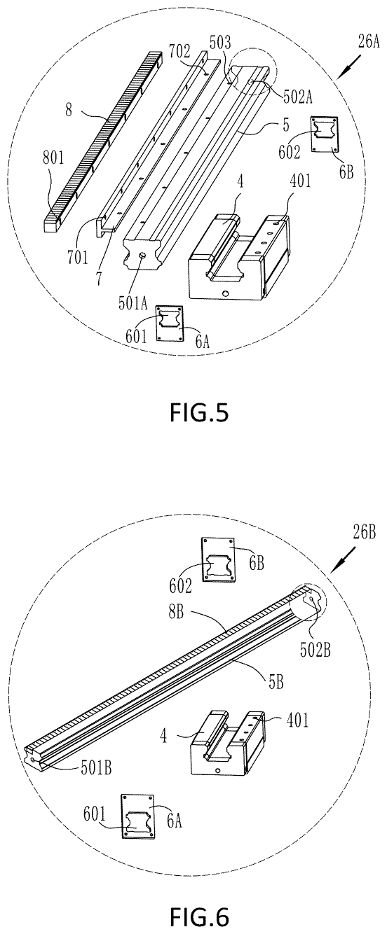

As shown in FIG. 6, the integrated rack and guide rail sliding assembly 26B differs from the rack and guide rail combination sliding assembly 26A only in that the rack and guide rail is a composite structure, where the second rack 8B is integrated with the rail 5B. This design is simpler compared to the structure in FIG. 5 where the first rack 8 is fixed to the rail 5 using a rack mounted bracket 7. Despite its simplicity, it still effectively achieves the function of the rack driving the rail in linear motion. One end of the rack and guide rail complex 5B is equipped with a complex third fixing hole 501B, through the first flange 6A to be fixed to the bearing box 2. While the other end has a complex fourth fixing hole 502B, through the second flange 6B to be fixed to the bearing box 2. The rail 5B is slidably mounted and fixed inside the linear block 4.

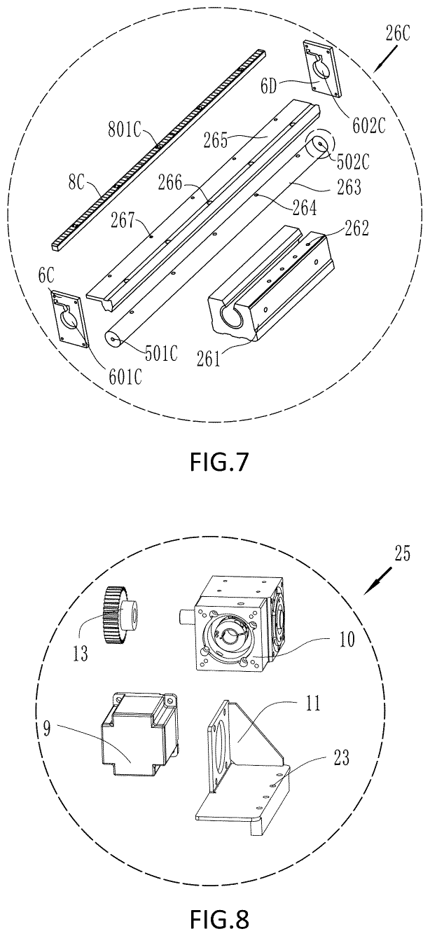

As shown in FIG. 7, the rack and linear shaft combination sliding assembly 26C includes a linear open slider 261, an open slider fixing hole 262, a linear shaft 263, multiple linear shaft fixing hole 264, a linear shaft bracket 265, multiple bracket first fixing hole 266 and bracket second fixing hole 267, a linear shaft fifth fixing hole 501C, a linear shaft sixth fixing hole 502C, a third flange 6C, a fourth flange 6D, an shaft third support hole 601C, and an shaft fourth support hole 602C.

As shown in FIG. 7, the third rack connecting hole three 801C is arranged correspondingly to the bracket second fixing hole 267 and is used to fix the third rack 8C and the linear shaft bracket 265. The bracket first fixing hole 266 and the linear shaft fixing hole 264 are arranged correspondingly and are used to connect the linear shaft bracket 265 and the linear shaft 263. The third rack 8C is fixedly connected to the linear shaft 263 through the linear shaft bracket 265, and the linear shaft 263 is slidably fixed in the linear open slider 261. The linear shaft fifth fixing hole 501C is arranged correspondingly to the third flange 6C and the shaft third support hole 601C. The linear shaft 263, the third rack 8C and the linear shaft bracket 265 are arranged correspondingly to the shaft third support hole 601C on the third flange 6C and the shaft fourth support hole 602C on the fourth flange 6D. The linear shaft 263, third rack 8C and linear shaft bracket 265 pass through the corresponding shaft third support hole 601C and shaft fourth support hole 602C, transferring the weight to third flange 6C and fourth flange 6D.

Referring to FIGS. 8 and 7, the driving device 25 includes a motor 9, a reducer 10, a driving seat 11 and a gear 13. The output shaft of the motor 9 is connected to the reducer 10, and which is installed on the driving seat 11. The output shaft of the reducer 10 is attached to the gear 13. The motor 9 drives the gear 13 to rotate through the reducer 10. A driving seat fixing hole 23 is provided on the driving seat 11. The driving seat fixing hole 23 corresponds to the linear block fixing hole 401 or the linear open slider fixing hole 262 and is used to fix the driving seat 11 on the linear block 4 or the linear open slider 261.

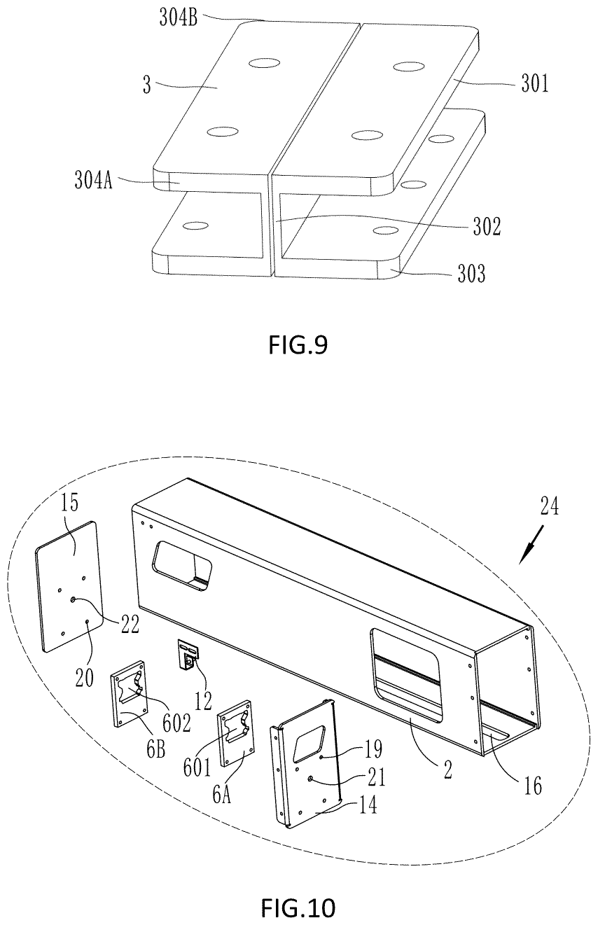

Referring to FIG. 9 and FIG. 7, the support frame 3 includes a top plate 301, a vertical plate 302 and a bottom plate 303. The top plate 301 has a first end face 304A and an second end face 304B. The linear block 4 or the linear open slider 261 is fixed on the top plate 301, and the bottom plate 303 is installed on the vehicle body 27.

Referring to FIG. 10 and FIG. 7, the carriage box assembly 24 includes a bearing box body 2, a control assembly 12, a load-bearing inspection plate 14, a load-bearing plate 15, a first flange 6A and a second flange 6B, or a third flange 6C and a fourth flange 6D. The control assembly 12 is arranged on the side wall inside the bearing box body 2. The load-bearing inspection plate 14 is detachable for easy maintenance. A flange first fixing hole 9 and multiple guide rail first connecting holes 21 are provided on the load-bearing inspection plate 14. The first flange 6A or the third flange 6C is fixed to the load-bearing inspection plate 14 through the flange first fixing hole 9. The first flange 6A or the third flange 6C is provided with a guide rail support hole one 601 or a shaft third support hole 601C through which the guide rail 5 or the rack and guide rail complex 5B or the linear shaft 263 can pass. One end of the guide rail 5 or the rack and guide rail complex 5B or the linear shaft 263 passes through the first flange 6A or the third flange 6C and is fixed to the load-bearing inspection plate 14 through the combined guide rail first fixing hole 501A or the complex third fixing hole 501B or the linear shaft fifth fixing hole 501C and the guide rail first connecting hole 21.

Referring to FIG. 10 and FIG. 7, the load-bearing plate 15 is provided with a flange second fixing hole 20 and a guide rail second connecting hole 22. The second flange 6B or the fourth flange 6D is fixed to the load-bearing plate 15 through the flange second fixing hole 20. The second flange 6B is provided with a guide rail support hole two 602 for allowing the guide rail 5 or the rack and guide rail complex 5B to pass through. The other end of the guide rail 5 or the rack and guide rail complex 5B or the linear shaft 263 passes through the second flange 6B or the fourth flange 6D and is fixed to the load-bearing plate 15 through the combined guide rail second fixing hole 502A or the complex fourth fixing hole 502B or the linear shaft sixth fixing hole 502C and the guide rail 5 or the rack and guide rail complex 5B or the linear shaft 263 and the guide rail second connecting hole 22. A long strip opening 16 is provided at the bottom of the bearing box body 2, and the long strip opening 16 slides back and forth from both sides of the vertical plate 302.

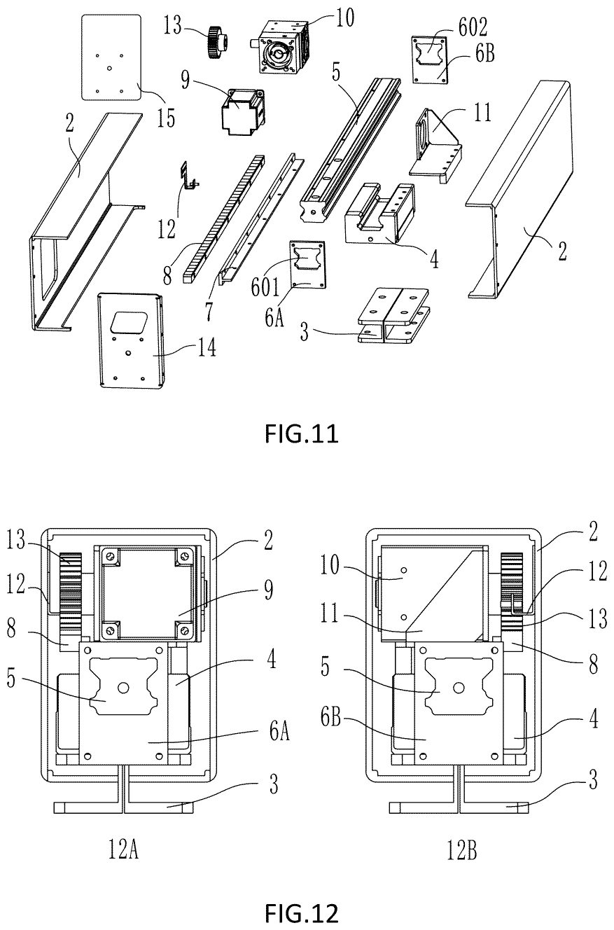

Referring to FIG. 11, is an exploded schematic diagram of the internal structure of the carriage box assembly 24.

Referring to FIG. 12, FIG. 12A is the front view of the interior of the carriage box assembly 24, FIG. 12B is the rear view of the interior of the carriage box assembly 24, FIG. 12C is the front view of the rack shaft combination inside the carriage box assembly 24, and FIG. 12D is the rear view of the rack shaft combination inside the carriage box assembly 24, it can be seen that the connection relationship between the driving device 25, the sliding assembly 26 and the support frame 3 inside the carriage box assembly 24.

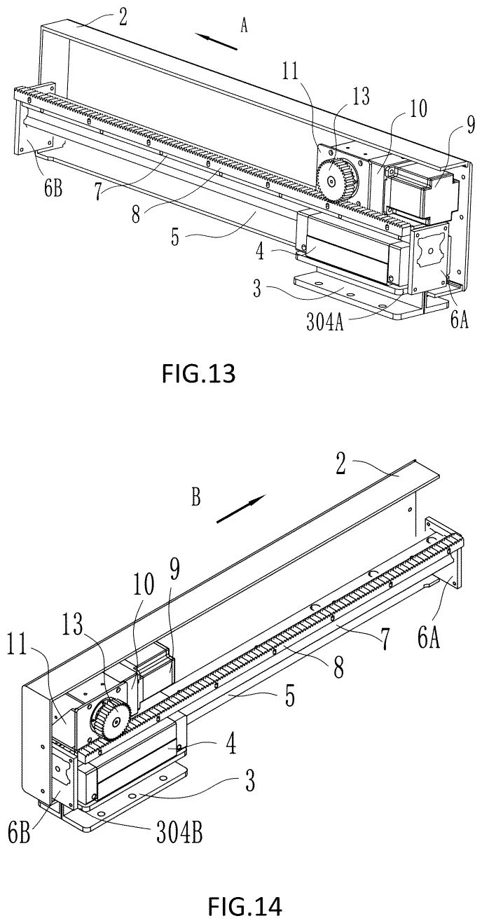

Referring to FIG. 13, is a schematic diagram of the internal structure of the vehicle box slide-out system when it is completely slid out, as shown in direction A.

Referring to FIG. 14, is a schematic diagram of the internal structure of the vehicle box slide-out system when it is fully retracted, as shown in direction B.

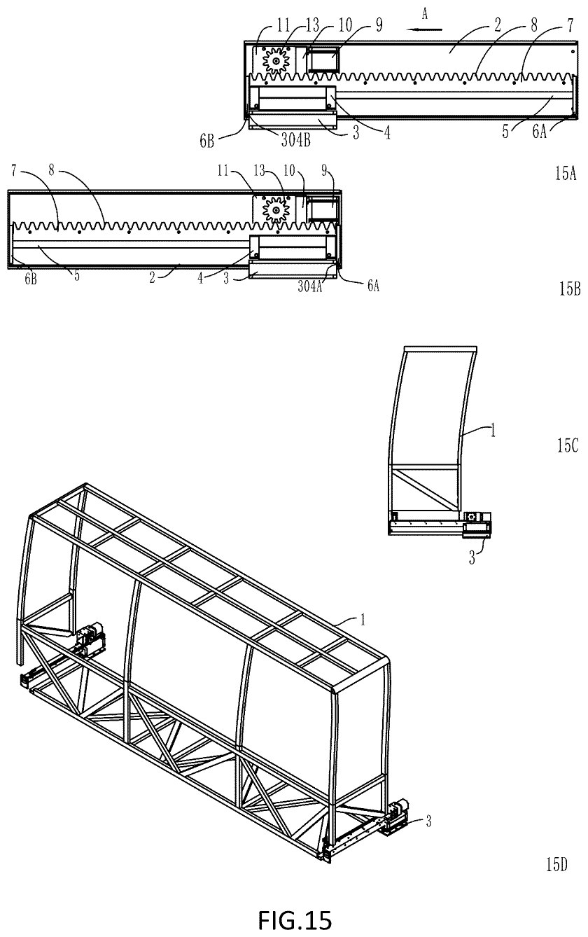

Referring to FIG. 15 and FIG. 7, is the schematic diagram of the vehicle box slide-out system, the motor 9 of the drive device 25 drives the gear 13 to rotate through the reducer 10, the gear 13 is meshed with the first rack 8 or second rack 8B or third rack 8C, and the spiral motion is converted into the linear motion, the gear 13 drives the guide rail 5 or the rack and guide rail complex 5B or the linear shaft 263 to slide out, the guide rail 5 or the rack and guide rail complex 5B or the linear shaft 263 drives the carriage box assembly 24 to slide out, the carriage box assembly 24 drives the slide-out box 1 to slide out, when the first flange 6A touches the first end face 304A or the third flange 6C touches the first end face 304A, the sliding motion stops, and the slide-out box 1 slides out completely.

Referring to FIG. 15 and FIG. 7, the slide-out box 1 slides out through the long opening 16 at the bottom of the bearing box body 2. After the slide-out box 1 slides out, the bearing box body 2 bears the weight of the slide-out box 1 and transfers the weight to the guide rail 5 or the rack and guide rail complex 5B or the linear shaft 263. The guide rail 5 or the rack and guide rail complex 5B or the linear shaft 263 transfers the weight to the linear block 4 or the linear open slider 261. The linear block 4 or the linear open slider 261 transfers the weight to the support frame 3. The support frame 3 transfers the entire weight of the slide-out box 1 to the vehicle body 27.

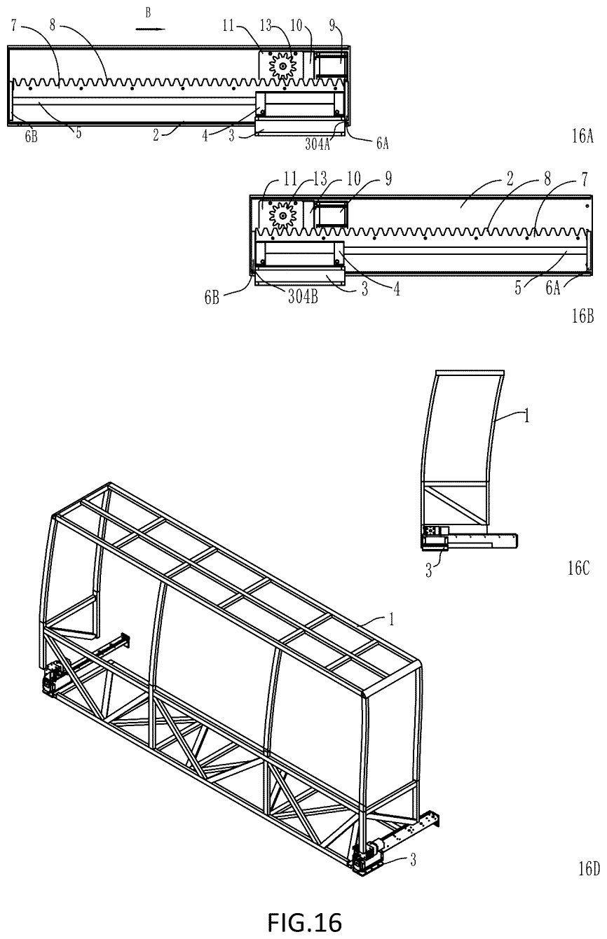

Referring to FIG. 16 and FIG. 7, is the schematic diagram of the vehicle box slide-out system retracting, the motor 9 of the driving device 25 drives the gear 13 to reverse through the reducer 10, the gear 13 meshes with the first rack 8 or the second rack 8B or the third rack 8C and converts the spiral motion into linear motion. The gear 13 drives the guide rail 5 or the rack and guide rail complex 5B or the linear shaft 263 to retract, the guide rail 55 or the rack and guide rail complex 5B or the linear shaft 263 drives the carriage box assembly 24 to retract, the carriage box assembly 24 drives the slide-out box 1 to retract, when the second flange 6B hits the second end face 304B or the fourth flange 6D hits the second end face 304B, the retracting motion stops, and the slide-out box 1 is completely retracted. When the two bearing box assemblies 24 do not move synchronously, the control assembly 12 can detect the corresponding information, report the detected information to the controller, and the controller performs the corresponding operation.

Referring to FIG. 16 and FIG. 7, the load-bearing inspection panel 14 is removable. When a fault occurs inside the load-carriage box assembly 24. The load-bearing inspection plate 14 can be disassembled for inspection without opening the entire load-carriage box assembly 24, which is convenient for later use. The sliding assembly 26, the driving device 25, and part of the support frame 3 are integrated inside the load-carriage box assembly 24, which can save space, facilitate quick installation and disassembly, and has a beautiful appearance.

The above description of the disclosed embodiments enables one skilled in the art to implement or use the present invention. Various modifications to these embodiments will be apparent to one skilled in the art, and the general principles defined herein may be implemented in other embodiments without departing from the spirit or scope of the present invention. Therefore, the present invention will not be limited to the embodiments shown herein, but rather to the widest scope consistent with the principles and novel features disclosed herein.

1. A vehicle box slide-out system, comprising a slide-out box, a drive device, a sliding assembly, a support frame and a carriage box assembly, wherein the slide-out box is arranged at an opening of the vehicle body, the drive device is engaged with the sliding assembly, the sliding assembly is fixed above the support frame, the drive device and part of the support frame are integrated inside the carriage box assembly, a long strip opening is arranged at the bottom of the carriage box assembly, and the carriage box assembly slides back and forth at the lower end of the support frame through the long strip opening.

2. The vehicle box slide-out system described in claim 1, it is characterized in that when the vehicle is stationary, the slide-out box completely slides out from the opening of the vehicle body, thereby increasing the usable space inside the vehicle body, and after the slide-out box is retracted, it is flush with the exterior of the vehicle body, without affecting the overall aesthetic.

3. The vehicle box slide-out system as described in claim 2, it is characterized in that the sliding assembly has three types, namely a rack and guide rail combined sliding assembly, an integrated rack and guide rail sliding assembly, and a rack and linear shaft combined sliding assembly.

4. The vehicle box slide-out system as described in claim 3, it is characterized in that the rack and guide rail combined sliding assembly includes a linear block, a guide rail, a rack mounted bracket and a first rack. The guide rail is slidably connected with the linear block. One end of the guide rail is provided with a combined guide rail first fixing hole, the other end is provided with a combined guide rail second fixing hole, and the top is provided with multiple combined guide rail third fixing hole. The rack mounted bracket is provided with multiple rack mounted bracket first hole and rack mounted bracket second hole. The rack mounted bracket second hole and the combined guide rail third fixing hole are correspondingly arranged to connect the guide rail and the rack mounted bracket. The first rack is provided with multiple first rack first connection hole. The first rack first connection hole and the rack mounted bracket first hole is correspondingly arranged to connect the first rack and the rack mounted bracket. The first rack is fixed to the guide rail through the rack mounted bracket. The guide rail is slidably connected inside the linear block.

5. A vehicle box slide-out system according to claim 3, characterized in that the integrated rack and guide-rail sliding assembly comprises a second rack and guide rail complex and a linear block. The rack and guide-rail complex are provided with a second rack and a guide rail as a whole, one end of the rack and guide rail complex is provided with a complex third fixing hole, and the other end is provided with a complex fourth fixing hole, and the rack and guide rail complex are slidably fixed inside the linear block.

6. A vehicle box slide-out system as described in claim 3, it is characterized in that the rack and linear shaft combination sliding assembly includes a third rack, a third rack connecting hole three, a linear open slider, an open slider fixing hole, a linear shaft, multiple linear shaft fixing holes, a linear shaft bracket, multiple bracket first fixing hole and bracket second fixing hole, a linear shaft fifth fixing hole, a linear shaft sixth fixing hole, a third flange, a fourth flange; the third rack connecting hole three is correspondingly arranged with the bracket second fixing hole, and is used to connect the third rack and the linear shaft bracket, the bracket first fixing hole and the linear shaft fixing hole are correspondingly arranged, and are used to connect the linear shaft bracket and the linear shaft; the third rack is fixedly connected to the linear shaft through the linear shaft bracket, and the linear shaft is slidably fixed inside the linear open slider.

7. A vehicle box sliding-out system according to claim 1, characterized in that the driving device comprises a driving seat, a motor, a reducer and a gear, the output shaft of the motor is connected to the reducer, the reducer is installed on the driving seat, the output shaft of the reducer is connected to the gear, the motor drives the gear to rotate through the reducer, and the gear is meshed with the first rack, the second rack or the third rack.

8. A vehicle box sliding-out system according to claim 6 is characterized in that multiple fixing holes are provided on the linear block or linear open slider, and multiple drive seat mounting holes are provided on the drive seat. The drive seat mounting holes are arranged corresponding to the linear block or the linear open slider fixing hole and is used to fix the drive seat on the block or slider.

9. The vehicle box slide-out system according to claim 6 is characterized in that the support frame comprises a top plate, a vertical plate and a bottom plate, the top plate has first end face and second end face. The linear block or linear open slider is fixed on the top plate, the bottom plate is mounted on the vehicle body, and the carriage box assembly slides back and forth on both sides of the vertical plate through the long strip opening.

10. The vehicle box slide-out system according to claim 7 is characterized in that the carriage box assembly includes a bearing box body, a load-bearing inspection plate, a load-bearing plate, first flange and second flange or third flange and fourth flange. A load-bearing inspection plate is installed at one end of the bearing box body in the length direction, and a load-bearing plate is installed at the other end. One end of the guide rail or rack and guide rail complex or linear shaft is fixed to the load-bearing inspection plate through first flange or third flange, and the other end is fixed to the load-bearing plate through second flange or fourth flange.

11. A vehicle box slide-out system according to claim 8, characterized in that the load-bearing inspection plate is provided with multiple flange first fixing hole and guide rail first connecting hole, the first flange or third flange is fixed on the load-bearing inspection plate through the flange first fixing hole, the first flange or third flange is provided with the guide rail support hole one or the shaft third support hole that allow the guide rail or the rack and guide rail complex or the linear shaft to pass through. An end of the guide rail, which could be a linear guide or a rack and pinion rail, or a linear shaft passes through a specific flange (first flange or third flange). It then connects to a critical component, the guide rail first connecting hole, via an appropriate mounting hole (combined guide rail first fixing hole, complex third fixing hole, or linear shaft fifth fixing hole). Ultimately, this assembly is secured onto the load-bearing inspection plate.

12. A vehicle box slide-out system according to claim 8, characterized in that the load-bearing plate is provided with a flange second fixing hole and multiple guide rail second connecting hole, and the second flange or fourth flange is provided with a guide rail support hole two or an shaft fourth support hole through which the guide rail or the rack and guide rail complex or the linear shaft combination can pass. And the other end of the guide rail, which could be a linear guide or a rack and pinion rail, or a linear shaft passes through a specific flange (second flange or fourth flange). It then connects to a critical component, the guide rail second connecting hole, via an appropriate mounting hole (combined guide rail third fixing hole, complex fourth fixing hole, or linear shaft sixth fixing hole). Ultimately, this assembly is secured onto the load-bearing plate.

13. The vehicle box slide-out system according to claim 9, characterized in that the load-bearing plate is detachable.

14. A vehicle box slide-out system according to claim 10, characterized in that the carriage box assembly further comprises a control assembly, and the control assembly is disposed on a side wall inside the bearing box.
